(19) United States
(12) Patent Application Publication
(10) Pub. No.: US 2011/0238361 A1
(43) Pub. Date: Sep. 29, 2011

(54) TALLYING SYSTEM, TALLYING APPARATUS AND TALLYING METHOD

(76) Inventor: Kazuya Ueki, Tokyo (JP)

(21) Appl. No.: 12/671,838

(22) PCT Filed: Sep. 4, 2008
(86) PCT No.: PCT/JP2008/065998

§ 371 Date: Feb. 2, 2010

(30) Foreign Application Priority Data
Sep. 28, 2007 (JP) 2007-254372

(51) Int. Cl. G06F 15/00

(52) U.S. Cl. 702/127

(57) ABSTRACT

The object is to provide a tallying system, a tallying apparatus and a tallying method which are capable of tallying characteristics of non-users who have not perform predetermined use among visitors in a predetermined place.

Included here are: a characteristics presumption system which acquires visitor-count data by counting the number of visitors to a predetermined place based on predetermined input data and acquires characteristics presumption data by presuming visitor's characteristics based on the input data; a use state management system which acquires user data indicating the characteristics of users who have performed predetermined use among the visitors; and a tallying apparatus which generates tallying result data including at least a result of tallying about the characteristics of non-users besides the users among the visitors based on the visitor-count data and the characteristics presumption data received from the characteristics presumption system and the user data received from the use state management system.

### TECHNICAL FIELD

The present invention relates to a tallying system which tallies unspecified large number of people using various data and, more particularly, to a tallying system, a tallying apparatus and a tallying method for totaling the number relating to the state of arrival and the state of use in a predetermined place.

BACKGROUND ART

As a tallying system for tallying unspecified large number of people, a system which performs data tallying of genders, age groups and races (characteristics) or the like of the unspecified large number of visitors conveniently based on animation video data acquired using a video camera is disclosed in patent document 1, for example.
[Patent document 1] Japanese Patent Application Laid-Open No. 2007-58828

### DISCLOSURE OF THE INVENTION

### Problem to be Solved by the Invention

For example, in a store or the like, it is very useful for sales strategy or the like to grasp the characteristics (such as gender and age group) of a non-purchaser (non-user) who came to the store but did not purchase (use) among customers who came to (visited) the store.

However, a system of the above-mentioned patent document 1 cannot tally the characteristics of customers who did not purchased (used) (i.e., non-users) among customers who came to a store (visitors), for example, because the system only tallies the characteristics of visitors.

The present invention has been made in view of the above-mentioned problem, and the object of the present invention is to provide a tallying system, a tallying apparatus and a tallying method capable of tallying the characteristics of non-users who did not perform predetermined use among visitors in a predetermined place.

### Means for Solving the Problem

In order to achieve the object, a tallying system of the present invention comprises: a characteristics presumption system which acquires visitor-count data by counting the number of visitors to a predetermined place based on predetermined input data and acquires characteristics presumption data by presuming visitor's characteristics based on the input data; a use state management system which acquires user data indicating the characteristics of users who have performed predetermined use among the visitors; and a tallying apparatus which generates tallying result data including at least a result of tallying the characteristics of non-users besides the users among the visitors based on the visitor-count data and the characteristics presumption data received from the characteristics presumption system and the user data received from the use state management system.

A tallying apparatus of the present invention is an apparatus which is used in a tallying system of the present invention.

A tallying method of the present invention comprises: a first data acquisition step for acquiring visitor-count data by counting the number of visitors to a predetermined place based on predetermined input data and acquiring characteristics presumption data by presuming visitor's characteristics based on the input data; a second data acquisition step for acquiring user data indicating the characteristics of users who have performed predetermined use among the visitors; and a tallying step for generating tallying result data including at least a result of tallying the characteristics of non-users besides the users among the visitors based on the visitor-count data and the characteristics presumption data acquired in the first data acquisition step and the user data acquired in the second data acquisition step.

### Advantageous Effect of the Invention

According to the present invention, the characteristics of non-users who did not perform predetermined use among visitors to a predetermined place can be tallied.

### BEST MODE FOR CARRYING OUT THE INVENTION

Hereinafter, the best mode for carrying out the present invention will be described in detail with reference to accompanying drawings.

A tallying system of the present invention is a system which tallies unspecified large number of people using a plurality of pieces of data, and is a system which tallies arrival states and use states in a predetermined place (segments of visitors and purchasers in a store or the like, for example) to obtain a tallying result.

The structure of a tallying system according to an exemplary embodiment of the present invention is shown in FIG. 18.

As shown in FIG. 18, a tallying system of this exemplary embodiment is constituted of a use state management system 100, an age-and-gender presumption system 200, and a tallying apparatus 300. They are connected by a wire or connected wirelessly. According to this exemplary embodiment, the use state management system 100, and the age-and-gender presumption system 200 perform data communication with the tallying apparatus 300 via a predetermined network (such as LAN (Local Area Network), for example).

<Use State Management System>

The use state management system 100 is installed in a predetermined place (a store, for example), and obtains user data which indicates the age and the gender (examples of characteristics) of a user (purchaser) who has done predetermined use (purchase) among visitors to the predetermined place (store) (corners to the store). For example, user data is acquired from a recording medium (member's card and point card) possessed by a user in which the user data is recorded.

As an example of the use state management system 100, there is a POS (Point Of Sales) system capable of knowing a sales trend by collecting sales data (name, quantity and time of sale, etc.) of a commercial product at a place where sale and payment of the product is performed. A POS system in a checkout counter in such as a store includes a store sales management computer and a POS-corresponding register (POS terminal) with bar code scanner, and in the system, a barcode stuck to a product or the like is read by the POS-corresponding register at the time of checkout, and data collection, price calculation and receipt issuance is performed simultaneously. As a result, it is possible to know purchase product, purchase place, purchase time, and number of purchasing in real time.

As an example of the above-mentioned recording medium, there are a member's card and a point card (hereinafter, they are collectively referred to as “customer card”), which are cards possessed by each customer and are cards for receiving a predetermined privilege according to the purchase price or the like. On a customer card, the data relating to the customer (the name, age, gender, etc.: that is, the above-mentioned user data) is recorded. A purchaser (customer) shows this customer card to the store side (to a store staff) in charge of the POS register at the time of payment and clearing.

Thus, a POS system reads a customer card using a POS-corresponding register at the time of such as payment and clearing, and the system acquires user data. Then, it outputs (transmits) the acquired user data to the tallying apparatus 300 in real time or at a predetermined time intervals. At that time, it acquires date-and-time data which indicates the date and time when the user data has been acquired (15:32 of Aug. 1, 2007, for example) and outputs (transmits) the date-and-time data being attached to the user data. This is in order to show when the user has done the use (purchase) (when the user data to be outputted has been acquired). The system may acquire purchase price data which indicates the purchase price and outputs (transmits) the purchase price data with being attached to the user data. Therefore, from the user data, the date and time when the user has done the use (and the purchase price) and, the user's age and gender is known.

Further, a plurality of POS systems (the use state management systems 100) may exist.

<Age-and-Gender Presumption System>

The age-and-gender presumption system 200 acquires visitor-count data (data which indicates the total number of visitors) by counting the number of visitors to a predetermined place (a store, for example) (corners to the store) based on a predetermined input data (data which is at least one of image data and voice data, and which is acquired at the gateway of the predetermined place), and also acquires age-and-gender presumption data (this is an example of characteristics presumption data) by presuming the age and gender (this is examples of characteristics) of those visitors. The age-and-gender presumption system 200 comprises: a first presumption means for presuming the age and the gender of a visitor as a discrete quantity based on an input data; a second presumption means for presuming the age and the gender of a visitor as a continuous quantity based on the input data; and an integration means for integrating a presumed result of the first presumption means and a presumed result of the second presumption means, and acquiring it as age-and-gender presumption data. Then, it outputs (transmits) the acquired visitor-count data and age-and-gender presumption data to the tallying apparatus 300 in real time or at a predetermined time intervals. Meanwhile, it is desirable that output (transmission) of the visitor-count data and the age-and-gender presumption data is performed at predetermined time intervals (every one hour, for example), and also, in that case, it is desirable to append time-zone data which indicates a time zone (15:00-16:00 of Aug. 1, 2007, for example,) or the like when the visitor counting and the age gender presumption has been performed to the visitor-count data and the age-and-gender presumption data. This is in order to show when the visitors who have been counted and have been presumed their age and gender arrived. Therefore, the total number of visitors during a given time zone is known from the visitor-count data, and, as well, the ages and the genders of all of those visitors are known from the age-and-gender presumption data.

Now, hereinafter, each exemplary embodiment of the age-and-gender presumption system 200 will be described in detail. Meanwhile, according to the following each exemplary embodiment, although only presumption of age is described as an example, it is supposed that gender can be also presumed similarly. According to the following each exemplary embodiment, it is supposed that details of acquiring the age presumption data will be described. The age-and-gender presumption system 200 of the present invention is an example of a characteristics presumption system which presumes person's characteristics. Therefore, in the following each exemplary embodiment, although the age-and-gender presumption system 200 that presumes the age and the gender of a person will be described, it is not limited to presumption of age and gender, and characteristics besides these may be presumed.

### First Exemplary Embodiment

The structure of an age presumption system according to this exemplary embodiment is shown in FIG. 1.

This system has feature quantity extraction units 1 and 2, discrimination circuits 3 and 4, score-generation units 5 and 6 and an integration unit 7. It is possible to compose each of these units using exclusive hardware, and also they can be realized on a computer by a software processing.

The feature quantity extraction unit 1 extracts a feature quantity which is used by the discrimination circuit 3 for presumption of age from an input image. The feature quantity extraction unit 2 extracts a feature quantity which is used by the discrimination circuit 4 for presumption of age from the input image. The discrimination circuit 3 stores criterion data which has been already learned in advance and presumes the age of the person on an input image as a discrete quantity using the feature quantity extracted from the input image by the feature quantity extraction unit 1 and the criterion data. The discrimination circuit 4 stores criterion data which has been already learned in advance and presumes the age of the person on an input image as a continuous quantity using the feature quantity extracted from the input image by the feature quantity extraction unit 2 and the criterion data. The score-generation unit 5 generates the score of a presumed result (discrete quantity) outputted from the discrimination circuit 3. The score-generation unit 6 generates the score of a presumed result (continuous quantity) outputted from the discrimination circuit 4. The integration unit 7 integrates the scores outputted from each of the score-generation units 5 and 6. Meanwhile, a score is a numerical value which indicates the correlation of a certain presumed result (discrete quantity and continuous quantity) outputted from a discrimination circuit and age information (the actual age and the appearance age of a target person of presumption). Details of processing of score generation will be described in the latter part of the following description.

To the processing for presuming the age of a person from the feature quantity using criterion data already learned by the discrimination circuits 3 and 4, publicly known methods can be applied. To the discrimination circuit 3 that presumes the age of a person as a discrete quantity, techniques of such as the linear discriminant analysis (LDA), the mixture Gaussian distribution model (GMM) and Support Vector Machine can be applied. To the discrimination circuit 4 that presumes the age of a person as a continuous quantity, techniques of such as the multi regression analysis, the neural network and Support Vector Regression can be applied.

To the processing in which the feature quantity extraction units 1, 2 extracts a feature quantity from an input image, publicly known methods can be applied and, more specifically, techniques such as the edge detection and the binarization can be applied.

The processing of the score-generation unit 5 for generating a score from a discrete quantity which is a presumed result outputted from the discrimination circuit 3 will be described. As mentioned above, a score is a numerical value which indicates the correlation between a certain presumed result and age information, and is indicated as a linear function in a rectangular coordinate system in which age is adopted as the other axis. An example of generating a score when the discrimination circuit 3 selects any one of classes and outputs a presumed result is shown in FIG. 2. The vertical axis of graphs in this Figure represents score Sc of discrete quantity and the horizontal axis represents age. Here, a case when the discrete quantity of “the 20s” has been outputted from the discrimination circuit 3 as a presumed result is shown as an example.

In the case of (a), a score is generated such that it is a fixed numerical value for ages of not less than 20 years old and less than 30 years old which come under the 20s. In the case of (b), a score is generated such that the highest value is assigned to 25 years old which is the median in the class of the 20s, and the larger the distance between the median and an age is, the more the score declines in a linear manner. In the case of (c), a score is generated such that it is of a shape of a normal distribution having 25 years old which is the median in the class of the 20s as the center.

An example of generating a score when the discrimination circuit 3 outputs a presumed result as a probability corresponding to each class is shown in FIG. 3. Like FIG. 2, the vertical axis of graphs in this Figure represents score Sc of discrete quantity and the horizontal axis represents age. Here, a case where a presumed result of 10% for the 0s, 20% for the 10s, 50% for the 20s, 10% for the 30s, 5% for the 40s and 5% for the 50s is outputted as discrete quantity is shown as an example.

In the case of (a), a score is generated such that it is a fixed numerical value for an age in a class according to the probability for each class. In the case of (b), a score is generated such that the value at the median of each class is the highest, and the larger the distance between the median and an age is, the more the score declines in a linear manner. In the case of (c), a score is generated such that it is of a normal distribution having the median of each class as the center.

An example of processing of the score-generation unit 6 is shown in FIG. 4. The vertical axis of graphs in this figure represents score of continuous quantity and the horizontal axis represents age. As shown in (a), a score may be generated such that it is a fixed numerical value for an age within the range of ±α from an output value of the discrimination circuit 4. Also, as shown in (b), a score may be generated such that the score value of an output value of the discrimination circuit 4 is the highest, and the larger the distance between the output value and an age is, the more the score of the age declines in a linear manner. As shown in (c), a score may be generated such that it is of a normal distribution having an output value of the discrimination circuit 4 as the center.

The integration unit 7 integrates Sc and Sr inputted from the score-generation unit 5 and 6, respectively.

As shown in FIG. 5, the age at which score St after integration (FIG. 5 (c)) which is obtained by combining score Sc of discrete quantity (FIG. 5 (a)) and score Sr of continuous quantity (FIG. 5 (b)) takes the peak value is outputted as an integration result (age presumption data). The output destination is the tallying apparatus 300.

Further, at the time of integration, weighting may be performed according to the precision of the discrimination circuits 3 and 4. That is, when the weights of the discrimination circuits 3 and 4 are named as Wc and Wr, respectively, score St after integration is represented as St=Wc*Sc+Wr*Sr.

Therefore, in a case where one of the discrimination circuits 3 and 4 is more highly precise than the other, precision of presumption improves by making the weight of the more precise discrimination circuit large.

Also, the precision of presumption is improved by changing the weights for each class. For example, because the discrimination circuit 3 that handles discrete quantity is highly precise in presumption for young age groups and for high age groups, precision of age presumption increases by making the weights of these classes large. Specifically, when the weight of the discrimination circuit 3 in “the Xs” is represented with Wc^{(x)}, by setting Wc⁽⁰⁾=1.0, Wc⁽¹⁰⁾=0.5, Wc⁽²⁰⁾=0.3, Wc⁽³⁰⁾=0.3, Wc⁽⁴⁰⁾=0.3, Wc⁽⁵⁰⁾=0.5 and Wc⁽⁶⁰⁾=1.0, precision of age presumption for younger age groups and higher age groups is improved.

Although age at which score St which is obtained by integrating score Sr of continuous quantity and score Sc of discrete quantity takes the maximum value is calculated as continuous quantity, it is possible to make an output of the integration unit 7 discrete quantity. As a method to convert an output of the integration unit 7 into discrete quantity, there are a method to make the class to which the age at which score St takes the maximum value belongs an integration result and a method to make the class where its area as a result of integration of score St on a class-by-class basis becomes biggest an integration result. In an example of FIG. 6, “the 10s” in the case of the former method and “the 20s” in the case of the latter method will be outputted from the integration unit 7 as a discrete quantity of an integration result.

Although both methods may be used, the latter method is more excellent in terms of the stability of presumption accuracy.

Thus, because an age presumption system according to this exemplary embodiment integrates a presumed result obtained as a discrete quantity and a presumed result obtained as a continuous quantity, there are no cases that precision of presumption of a specific age group becomes low.

Moreover, by integrating a score based on a presumed result obtained as a discrete quantity and a score based on a presumed result obtained as a continuous quantity giving weight to them, it is possible to improve the presumption accuracy further. In this case, the precision of presumption can be made higher by changing the weight according to a class.

### Second Exemplary Embodiment

The structure of an age presumption system according to this exemplary embodiment is shown in FIG. 7. Although it is a structure almost similar to that of the first exemplary embodiment, the score-generation units 5 and 6 can refer to criterion data which each of the discrimination circuits 3 and 4 uses for presumption of age.

Processing of the feature extraction units 1 and 2, and the integration unit 7 are the same as that of the first exemplary embodiment.

In this exemplary embodiment, the score-generation unit 5 generates a score of a presumed result with reference to criterion data of the discrimination circuit 3. When age information is included in criterion data used for learning as a parameter, the distribution of age information of a person presumed to belong to a specific age group can be extracted by making a reverse lookup of the criterion data of the discrimination circuit 3. Therefore, the score-generation unit 5 extracts data which should be presumed to be a specific age group from the criterion data of the discrimination circuit 3 and outputs its distribution as a score of the age group as shown in FIG. 8 (a).

Similarly, the score-generation unit 6 generates a score of a presumed result with reference to the criterion data of the discrimination circuit 4. When age information is included in criterion data used for learning as a parameter, the age information of a person presumed to belong to a specific age group can be extracted by making a reverse lookup of the criterion data of the discrimination circuit 4. Therefore, the score-generation unit 6 extracts data which should be presumed to be in a range off a from a specific age from the criterion data of the discrimination circuit 4 and outputs its distribution as a score of the age as shown in FIG. 8 (b).

Age information of a person presumed to be in a certain age group may not be symmetrical distribution about the median of the age group. For example, the distribution of age information of persons Presumed to be in their 20s generally becomes higher than the age of 25 which is the median, because there are more cases in which a person in his/her 30s, an age group in which specific characteristics do not appear easily, is presumed as in his/her 20s than cases in which a person in his/her 10s, an age group in which specific characteristics appear easily, is presumed as in his/her 20s. This is also similar in the case of continuous quantity, and age information of persons presumed to be in a certain age may not be symmetrical distribution about the age.

In this exemplary embodiment, it is possible to presume age more correctly, because a score for a discrete quantity and a continuous quantity is generated using criterion data used for presumption of age.

The score for a discrete quantity and a continuous quantity is integrated in the integration unit 7 like the first exemplary embodiment as shown in FIG. 8 (c), and an integration result (age presumption data) is outputted as a discrete quantity or a continuous quantity. The output destination is the tallying apparatus 300.

Further, although a case in which a scored is generated based on criterion data used by the discrimination circuits 3 and 4 for presumption of age has been described here, when there is measured data (including the relation between age information and a presumed result) which the discrimination circuits 3 and 4 have not learned, the score-generation units 5 and 6 may perform process of generating a score based on that, as shown in FIG. 9.

### Third Exemplary Embodiment

The structure of an age presumption system according to this exemplary embodiment is shown in FIG. 10. In this exemplary embodiment, there are provided two discrimination circuits (4a and 4b) which presume age of a person as a continuous quantity, and feature quantities A and B extracted by the feature quantity extraction unit 2 are inputted separately.

The score-generation unit 6 outputs score Sr of continuous quantity based on presumed results inputted from discrimination circuits 4a and 4b, respectively.

An example of processing of the score-generation unit 6 is shown in FIG. 11. The score-generation unit 6 combines a score based on a presumed result inputted from the discrimination circuit 4a (FIG. 11 (a)) and a score based on a presumed result inputted from the discrimination circuit 4b (FIG. 11 (b)), and calculates score Sr (FIG. 11 (c)) of continuous quantity.

The score of combined continuous quantity is integrated with the score of the discrete quantity in the integration unit 7 like the first exemplary embodiment, and an integration result (age presumption data) is outputted from the integration unit 7 as a discrete quantity or a continuous quantity. The output destination is the tallying apparatus 300.

Thus, by generating a score by combining presumed results which are outputted from a plurality of discrimination circuits, a measurement error is reduced and the presumption accuracy is improved.

Meanwhile, although the structure in which the feature quantity extraction unit 2 extracts two feature quantities to input to the separate discrimination circuit 4a and 4b has been described as an example here, a plurality of feature extraction units themselves may be provided as shown in FIG. 12, or a same feature quantity may be inputted to separate discrimination circuits as shown in FIG. 13. When a same feature quantity is inputted to different discrimination circuits, the similar effect is obtained, because when learned pieces of criterion data are different, outputted presumed results are different.

Although the case where presumed results of two discrimination circuits are combined has been described as an example here, it is needless to say that the structure may be such that presumed results of discrimination circuits of no smaller than 3 are combined.

### Fourth Exemplary Embodiment

The fourth exemplary embodiment in which the present invention is implemented suitably will be described.

The structure of an age presumption system according to this exemplary embodiment is shown in FIG. 14. In this exemplary embodiment, there are provided two discrimination circuits (3a and 3b) which presume age of a person as a discrete quantity, and feature quantities C and D extracted by the feature quantity extraction unit 1 are inputted separately.

The score-generation unit 5 outputs score Sc of discrete quantity based on presumed results inputted from discrimination circuits 3a and 3b, respectively.

Because it is the same as that of the third exemplary embodiment except that the target of combining is a score of discrete quantity, the overlapped description will be omitted.

### Fifth Exemplary Embodiment

The fifth exemplary embodiment in which the present invention is implemented suitably will be described.

The structure of an age presumption system according to this exemplary embodiment is shown in FIG. 15. This system has the feature quantity extraction units 11, 12, 21 and 22, discrimination circuits 13, 14, 23 and 24, score-generation units 15, 16, 25 and 26, and an integration unit 17.

A first input image is inputted to the feature quantity extraction units 11 and 12, and a second input image is inputted to the feature quantity extraction units 21 and 22. The feature quantity extraction units 11 and 21 are similar to the feature quantity extraction unit 1 of the first exemplary embodiment, the feature quantity extraction units 12 and 22 to the feature quantity extraction unit 2 of the first exemplary embodiment, the discrimination circuits 13 and 23 to the discrimination circuit 3 of the first exemplary embodiment, the discrimination circuits 14 and 24 to the discrimination circuit 4 of the first exemplary embodiment, the score-generating units 15 and 25 to the score-generating unit 5 of the first exemplary embodiment, the score-generating units 16 and 26 to the score-generating unit 6 of the first exemplary embodiment and the integration unit 17 to the integration unit 7 of the first exemplary embodiment, respectively.

An age presumption system according to this exemplary embodiment calculates score Sc1 of discrete quantity and Sr1 of continuous quantity based on an input image 1, and score Sc2 of discrete quantity and Sr2 of continuous quantity based on an input image 2 separately, and obtains a presumed result by integrating these.

Because processing in each part is the same as that of each of the above-mentioned exemplary embodiments, the description will be omitted.

Because an age presumption system according to this exemplary embodiment presumes age based on a plurality of images, even when shooting condition of any one of images is bad and a feature quantity cannot be extracted well, age can be presumed from the other images, and thus, precision of age presumption becomes high. Meanwhile, in this exemplary embodiment, although a case where there are two input images has been described, presumption may be performed using input images of no smaller than 3.

Further, each of the above-mentioned exemplary embodiments is an example of suitable implementation of the present invention, and the present invention is not limited to this.

For example, in each of the above-mentioned exemplary embodiment, although a case where the age of a person is presumed based on an input image has been described as an example, the gender of a person may be presumed instead of the age. In this case, by digitizing the gender of a woman as ‘1’ and a man as ‘0’, it can be presumed as a discrete quantity and a continuous quantity like the case of age. As shown in FIG. 16, by performing the same processing as each of the above-mentioned exemplary embodiment in parallel, the age and the gender of a person may be presumed simultaneously (in this case, age-and-gender presumption data will be acquired).

Data which is used as the base of presumption is not limited to an image, and it may be voice and the like, and it may be a combination of data of no smaller than two kinds of form (voice+image, for example).

Thus, various modifications of the present invention are possible.

According to each of the above-mentioned exemplary embodiment, although processing until age presumption data is outputted (transmitted) from the integration unit 7 to the tallying apparatus 300 has been described, an age presumption system according to each of the exemplary embodiments has a counter (not shown) to count a person (an object of age presumption) on an input image and outputs (transmits) the result to the tallying apparatus 300 along with age presumption data as the-number-of-people count data (the above-mentioned visitor-count data) as needed.

As it has been described above, age-and-gender presumption data obtained by the age-and-gender presumption system 200 of the present invention will be data which realizes presumption of a high degree of accuracy without the presumption accuracy declining in specific numerical value zones. Therefore, because total result data which is generated by the tallying apparatus 300 mentioned later is generated based on this age-and-gender presumption data, it will be reliable total result data in counting unspecified large number of people. The reason will be described below.

Conventionally, as a kind of system that presumes a numerical value which is impossible to be determined its quantity physically based on characteristics that are extracted from inputted information, there is a system that presumes a characteristics (the age and the gender, for example) of a person by extracting the characteristics of the person from an input image data, and comparing the extracted characteristics with data already learned in advance. As such a system, as shown in FIG. 17, a system having a feature quantity extraction unit that extracts a feature quantity from an input image and a discrimination circuit that presumes age by comparing the extracted feature quantity with data learned in advance is related, for example.

In the above-mentioned related system, as a discrimination circuit which presumes age by processing extracted characteristics, there are cases where a presumed result is handled as a discrete quantity (patent document 1, for example), and where a presumed result is handled as a continuous quantity (Japanese Patent Application Laid-Open No. 2005-148880, for example).

For example, as disclosed in the above-mentioned patent document 1, when a presumed result is handled as a discrete quantity, the presumed result is outputted as data indicating to which of classes divided into age groups it corresponds. For example, when age is divided into classes categorized as the 0s (0-9 years old), 10s (10-19 years old), 20s (20-29 years old), 30s (30-39 years old), 40s (40-49 years old), 50s (50-59 years old) and no smaller than 60 (60 years old or more), one of the class names such as “the 20s” or “the 50s” is selected and outputted as a presumed result.

However, in this case, there is a problem of how to classify age groups. For example, there is a problem about degree of width to divide the class, or about a reference (the median) to divide age groups (for example, even if 10-years-old width which is same as the above-mentioned example classification is employed, classification of such as 15-24 years old can be also considered). Also, when 20s (20-29 years old) and 30s (30-39 years old) are separated, there is a problem that overall accuracy falls, because data of two ages such as 29 years old and 30 years old which have no large difference is forced to be separated.

When a specific characteristic cannot be extracted from an image, the class into which the image is classified easily and the class into which the image is not classified easily occur. That is, although age can be presumed accurately about young age groups and old age groups in which specific characteristics are easy to be observed, it is difficult to presume accurately about rising generation groups and middle age groups in which specific characteristics is not easy to be observed. Therefore, when a system that handles a presumed result as discrete quantity is applied to a customer base analysis in a store or the like, outputs for a specific class such as young age groups and old age groups increase, and outputs for a specific class such as rising generation groups and middle age groups reduce, and as a result the customer base cannot be analyzed accurately.

On the other hand, as disclosed in Japanese Patent Application Laid-Open No. 2005-148880, for example, when a presumed result is handled as a continuous quantity, because a discrimination circuit learns such that a residual error may be minimized at the stage of learning, when an attempt to improve the overall performance is performed, a tendency for an presumed result to be drawn to the center appears. That is, there is a tendency in which the younger an age is than the average age, the older the age is presumed, and the older an age is than the average age, the younger the age is presumed, and thus it is difficult for ages of young age groups and old age groups to be presumed accurately.

Thus, there is a problem that precision of presumption of the age (the gender) of a person in a specific age group becomes low in the above-mentioned related technology.

Therefore, when tallying is performed using an age (gender) presumption system to which the above-mentioned related technology is applied and by combining an arrival state and a use state in a predetermined place (segments of visitors and purchasers in a store or the like, for example), the presumption accuracy of the arrival states becomes low in particular, because presumption of age (gender) is not accurate. As a result, there is a problem that precision of a result of tallying in which an arrival state and a use state in a predetermined place are combined is also becomes low, and thus a reliable tallying result cannot be obtained.

The present invention can also resolve the above-mentioned problem, because, in a presumption of an arrival state, a reliable tallying result can be obtained about an arrival state and a use state in a predetermined place by realizing presumption of a high degree of accuracy without the presumption accuracy declining in specific numerical value zones.

<Tallying Apparatus>

The tallying apparatus 300 receives visitor-count data and age-and-gender presumption data (and time-zone data) outputted (transmitted) from the age-and-gender presumption system 200 in real time or in a predetermined time intervals, and also receives user data (and date-and-time data) outputted from the use state management system 100.

Then, the tallying apparatus 300 tallies each of the received data and generates a tallying result as output data (tallying result data). In the occasion of the generation, the tallying apparatus 300 (a tallying unit 305 mentioned later) can associate the visitor-count data and the age-and-gender presumption data with the user data for each predetermined time-zone by associating the time-zone data attached to the visitor-count data and the age-and-gender presumption data with the date-and-time data attached to the user data.

Regarding timing of generation of tallying result data, the generation of tallying result data may be performed at a time (time or time zone) which is set by a user of the tallying apparatus 300 in advance, or may be performed when a generation instruction is received from the user. Regarding what kind of tallying result data should be generated, the user can configure the settings (that is, a type of tallying result data: refer to FIGS. 19-22 which are mentioned later, for example) in advance.

Although generated tallying result data will be data which indicates an arrival state and a use state based on visitor-count data, age-and-gender presumption data and user data, it is preferred that it includes a result in which at least one of age groups and genders of non-users (non-purchasers) besides users (purchasers) among visitors (corners to a store) is tallied.

The tallying apparatus 300 is an information processing terminal apparatus, and as shown in FIG. 18, it has: a reception unit 301 which is an interface for receiving user data, age-and-gender presumption data and visitor-count data; a user data memory unit 302 which store the user data received by the reception unit 301; an age-and-gender presumption data memory unit 303 which stores the age-and-gender presumption data received by the reception unit 301; a visitor-count data memory unit 304 which stores the visitor-count data received by the reception unit 301; a tallying unit 305 that receives each data (the user data, the age-and-gender presumption data and the visitor-count data) received by the reception unit 301 directly or reads each data (the user data, the age-and-gender presumption data and the visitor-count data) stored in the user data memory unit 302, the age-and-gender presumption data memory unit 303, and the visitor-count data memory unit 304, respectively, and generates tallying result data based on the respective pieces of data; a tallying result data memory unit 306 which stores the tallying result data generated by the tallying unit 305; and a transmission unit 307 which is an interface for receiving the tallying result data generated by the tallying unit 305 directly or reading the tallying result data stored in the tallying result data memory unit 306, and for transmitting (outputting) the tallying result data to outside (an external network or an external apparatus). These respective units can be composed using exclusive hardware or can be realized on a computer by software processing.

Further, although not being illustrated, the composition may be such that it has a display unit for indicating tallying result data (as well as each data stored in each of the data memory units 302, 303 and 304) and an operation unit for accepting a user operation. The transmission unit 307 may read each data stored in each of the data memory units 302, 303 and 304, and transmit (output) it to outside just as it is bypassing the tallying unit 305.

Although not being illustrated, the composition may be such that a clock unit that measures a year, a month, a day and time (including minute and second) may be included, and when the reception unit 301 receives each data, the clock unit may attach the date and time (a year, month, day and time) of the reception as date-and-time data to the received data, and then it may be stored in each of the data memory unit 302, 303 and 304. Therefore, when each data is received in real time, the above-mentioned date-and-time data (data attached to the user data) and the above-mentioned time-zone data (data attached to the age-and-gender presumption data and the visitor-count data) becomes unnecessary.

Here, hereinafter, tallying result data generated by the tallying unit 305 will be described specifically. Meanwhile, in the following description, it is supposed a case where tallying system of the present invention is installed in a store is described as an example. Therefore, it is supposed that generated tallying result data is based on store-corners-count data (visitor-count data) and age-and-gender presumption data which has been acquired by counting the number of persons who have come to the store (visitor) and by performing age and gender presumption in the age-and-gender presumption system 200, and also based on purchaser data (user data) acquired by reading a customer card presented by a purchaser (user) at the time of paying and clearing using a POS system (use state management system) 100.

An example of tallying result data is shown in FIG. 19. In FIG. 19 (a) and (b), female customers who have come to a store are tallied. Those female customers are classified into store corners, purchasers who have shopped among the store corners, and non-purchasers (non-purchasers=store corners−purchasers) who have not done shopping among the store corners. And FIG. 19 (a) and (b) show the numbers of those categories of people (vertical axis) as bar graphs for each age group (horizontal axis). FIG. 19 (a) is data which is tallied by averaging each data (store-corners count data, age-and-gender presumption data and purchaser data) in holidays (weekends and public holidays) of a certain one month, and FIG. 19 (b) is data which is tallied by averaging each data (store-corners count data, age-and-gender presumption data and purchaser data) in weekdays besides the holidays in the one month. Meanwhile, although “average” is adopted here, “total” may be adopted. Although data in holidays and weekdays have been taken here, alternatively, daily tallying result data (data which indicates the number of store corners, the number of purchasers and the number of non-purchasers for each age group on August 21, for example), weekly tallying result data (data which indicates the number of store corners, the number of purchasers and the number of non-purchasers for each age group in the third week in August, for example) and monthly tallying result data (data which indicates the number of store corners, the number of purchasers and the number of non-purchasers for each age group in August, for example).

When each individual tallying result data shown in FIG. 19 is compared with each other, it can be seen that, in holidays, the number of store corners and purchasers in their 20s are the largest, while in weekdays, although the number of store corners in their 20s is the largest, when it comes to purchasers, the number of purchasers in their 30s is the largest, for example. Therefore, in a store using a tallying system of the present invention, a measure for customer gathering (such as enhancement of buying-in of goods, change in the selection of goods and holding an event and the like, for example) can be performed appropriately, because the number of store corners, purchasers and non-purchasers can be grasped for each age group by analyzing (considering) tallying result data.

An example of tallying result data is shown in FIG. 20. FIG. 20 (a) is a diagram that female customers in their 20s who have come to a store in a certain one month period is totaled by averaging on a day of the week basis, showing the numbers of store corners, purchasers and non-purchasers (vertical axis) as a bar graph for each day of the week (horizontal axis). FIG. 20 (b) is a diagram that female customers in their 20s who have come to a store in a certain one year period is totaled by averaging on monthly basis, showing the numbers of store corners, purchasers and non-purchasers (vertical axis) as a bar graph for each month (horizontal axis). Meanwhile, although “average” is used here, it may be “total”.

From the tallying result data of FIG. 20 (a), it can be seen that the numbers of store corners on Saturdays and on Sundays are almost same, but the number of purchasers on Sundays is larger than that of Saturdays, for example. Also, from the tallying result data of FIG. 20 (b), it can be seen that there are a lot of store corners and purchasers in January, July and December, and that the number of non-purchasers exceeds the number of purchasers in June, for example. Therefore, in a store using a tallying system of the present invention, a measure for customer gathering (such as enhancement of buying-in of goods, change in the selection of goods and holding an event and the like, for example) can be performed appropriately, because the number of store corners, purchasers and non-purchasers can be grasped for each day of the week or on monthly basis by analyzing (considering) tallying result data.

For example, by generating and storing tallying result data of FIG. 20 (a) for each month, it is possible to compare it with the previous month. Similarly, for example, by generating and storing tallying result data of FIG. 20 (b) every year, it can be compared with the previous year.

An example of tallying result data is shown in FIG. 21. FIG. 21 (a) and (b) are diagrams that female customers in their 20s who have come to a store are tallied, showing the number of store corners, purchasers and non-purchasers (vertical axis) as a line graph for each time zone (horizontal axis). FIG. 21 (a) is data which is tallied by averaging each data (store-corners count data, age-and-gender presumption data and purchaser data) on holidays (weekends and public holidays) of a certain one month, and FIG. 21 (b) is data which is tallied by averaging each data (store-corners count data, age-and-gender presumption data and purchaser data) on weekdays besides the holidays in this one month. Meanwhile, although “average” is adopted here, “total” may be adopted. Although data on holidays and weekdays has been generated here, alternatively, daily tallying result data (data which indicates the number of store corners, the number of purchasers and the number of non-purchasers for each time zone in August 21, for example), weekly tallying result data (data which indicates the number of store corners, the number of purchasers and the number of non-purchasers for each time zone in the third week in August, for example) and monthly tallying result data (data which indicates the number of store corners, the number of purchasers and the number of non-purchasers for each time zone in August, for example) may be generated.

From tallying result data of FIG. 21 (a), on holidays, it can be seen that store corners and purchasers in time zones of from 14:00 to 16:00 are the largest, and that the number of non-purchasers exceeds the number of purchasers in time zones from 18:00 to 20:00. From tallying result data of FIG. 21 (b), it can be seen that the ratio of purchasers and non-purchasers is almost same for all time zones, and that the more time passes from opening, the more the number of store corners increases, and the number of store corners is the largest in time zones 18:00 and later. Therefore, in a store using a tallying system of the present invention, a measure for customer gathering (such as enhancement of buying-in of goods, change in the selection of goods and holding an event and the like, for example) can be performed appropriately, because the number of store corners, purchasers and non-purchasers can be grasped for each time zone (business hour zone) by analyzing (considering) tallying result data.

An example of tallying result data is shown in FIG. 22. FIG. 22 is a diagram that female customers in their 20s and 30s who have come to a store are tallied, showing the number of store corners, purchasers and non-purchasers of each of them (vertical axis) as a line graph for each time zone (horizontal axis). FIG. 22 is data which is tallied by averaging each data (store-corners count data, age-and-gender presumption data and purchaser data) on weekdays besides the holidays in a certain one month. Meanwhile, although “average” is adopted here, “total” may be adopted. Although data on weekdays has been generated here, alternatively, daily tallying result data (data which indicates the number of store corners, the number of purchasers and the number of non-purchasers for each time zone in August 21, for example), weekly tallying result data (data which indicates the number of store corners, the number of purchasers and the number of non-purchasers for each time zone in the third week in August, for example) and monthly tallying result data (data which indicates the number of store corners, the number of purchasers and the number of non-purchasers for each time zone in August, for example) may be generated.

From tallying result data of FIG. 22, the followings can be seen, for example.
In 20s, in time zones from 14:00 to 15:00, although there are the largest numbers of store corners, the number of purchasers is not large.
In 20s, there is not a big difference between the number of store corners and the number of purchasers in time zones from 18:00 to 20:00.
In 30s, there is a difference between the number of store corners and the number of purchasers in time zones from 15:00 to 16:00.
In 30s, number of non-purchasers exceeds the number of purchasers in time zones from 19:00 to 20:00.
Although store corners increases in 18:00 or later in 20s, store comers in their 30s decreases in 18:00 or later.
In 30s, in time zones from 10:00 to 13:00, there are more store corners than that of in 20s, and there is not so large difference between the number of store corners and the number of purchasers.

Therefore, in a store using a tallying system of the present invention, a measure for customer gathering (such as enhancement of buying-in of goods, change in the selection of goods and holding an event and the like, for example) can be performed appropriately, because the number of store comers, purchasers and non-purchasers of each age group can be grasped for each time zone (business hour zone) by analyzing (considering) tallying result data.

Meanwhile, in FIG. 22, although 20s and 30s are compared as an example, store corners, purchasers and non-purchasers of all age groups may be indicated in a line graph, or store corners, purchasers and non-purchasers of an age group designated by a user may be indicated in a line graph. An item to be indicated may be selected from the group of store corners, purchasers and non-purchasers by a user. As a result, it is possible to indicate only non-purchasers in their 30s, 40s, 50s, and to indicate only store comers of all age groups, for example.

Although the tallying result data in FIGS. 19-22 is shown as a bar graph and a line graph as an example, it may be of other types of graphs or a form besides a graph (table, for example).

Although the tallying result data on FIGS. 19-22 is data in which only women are tallied, it may be data in which only men are tallied, or may be data in which both men and women are tallied.

As it has been described above, because store corners, purchasers and non-purchasers can be grasped by analyzing (considering) tallying result data generated by a tallying system of the present invention, a measure for customer gathering (such as enhancement of buying-in of goods, change in the selection of goods and holding an event and the like, for example) can be performed appropriately in the side of a user of the system.

This application claims priority based on Japanese application Japanese Patent Application No. 2007-254372 filed on Sep. 28, 2007, and the disclosure thereof is incorporated herein in its entirety.

### BRIEF DESCRIPTION OF THE DRAWINGS

FIG. 1 A diagram showing a structure of an age presumption system according to the first exemplary embodiment in which the present invention is implemented suitably.

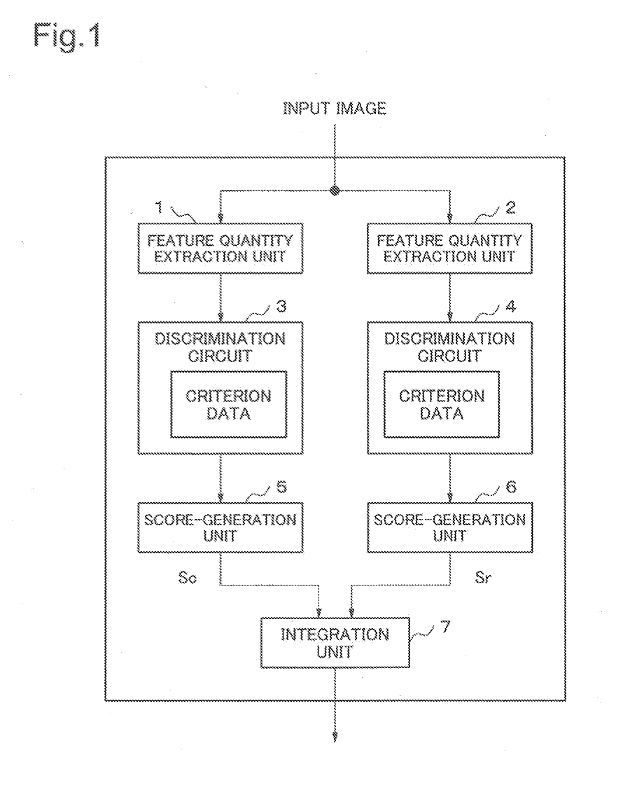

FIG. 2 A diagram showing an example of generating a score of discrete quantity

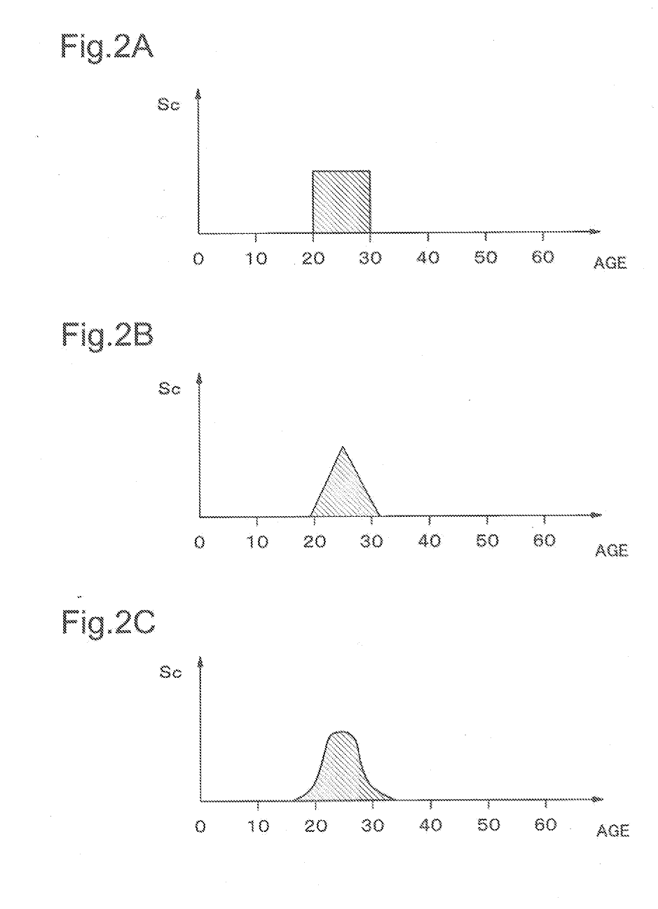

FIG. 3 A diagram showing an example of generating a score of discrete quantity

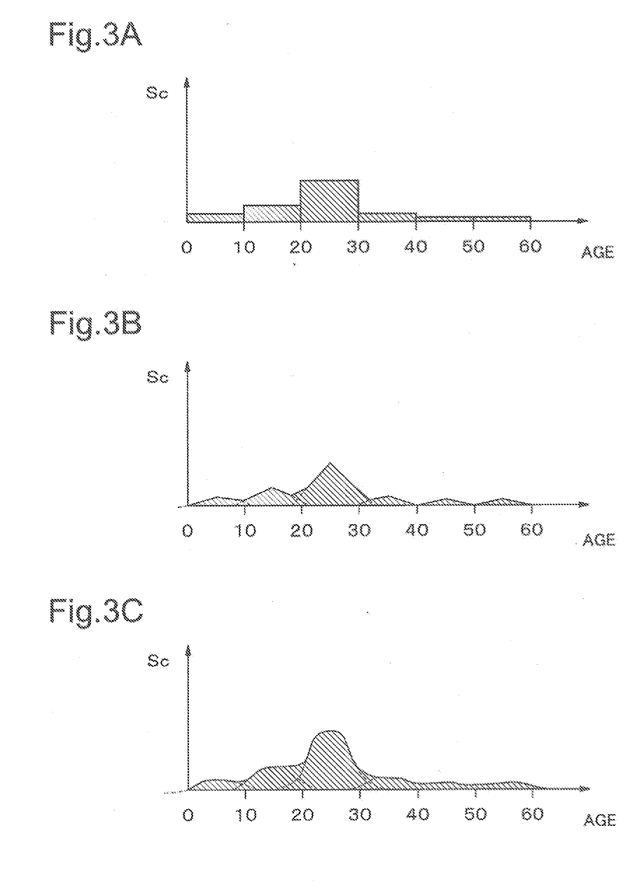

FIG. 4 A diagram showing an example of generating a score of continuous quantity

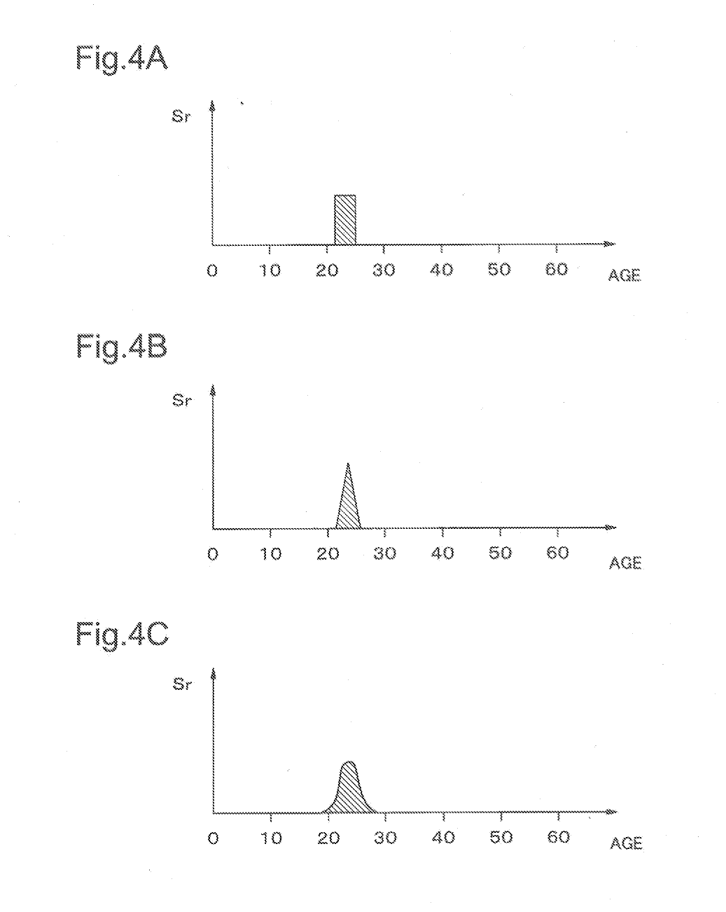

FIG. 5 A diagram showing an example of integration of a score of discrete quantity and a score of continuous quantity

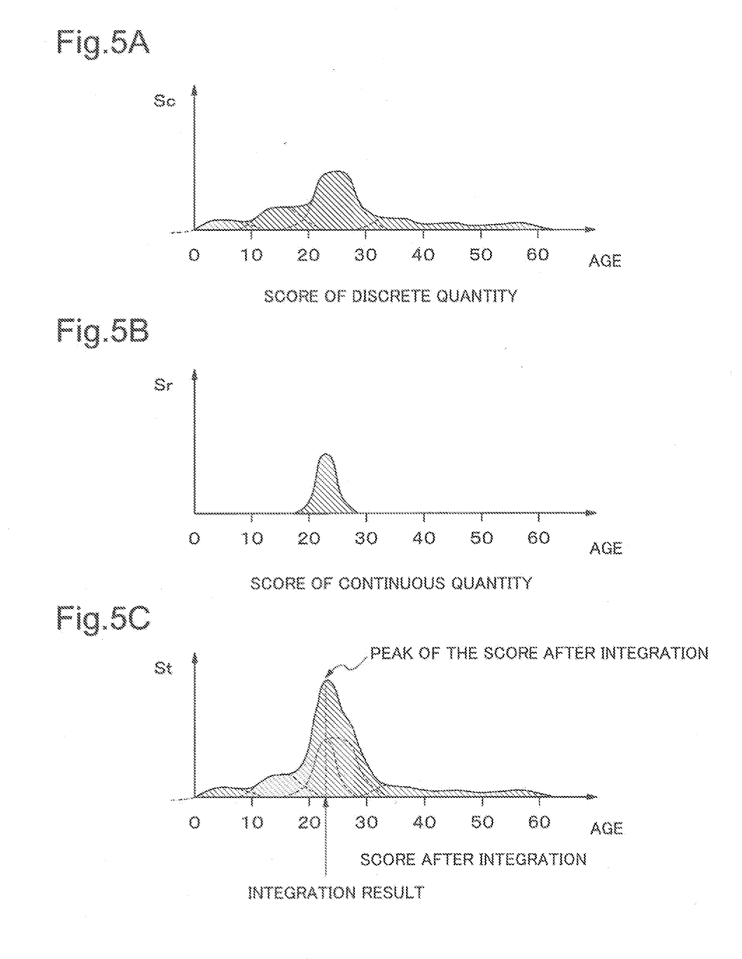

FIG. 6 A diagram showing an example of processing in which an integration result is changed into a discrete quantity

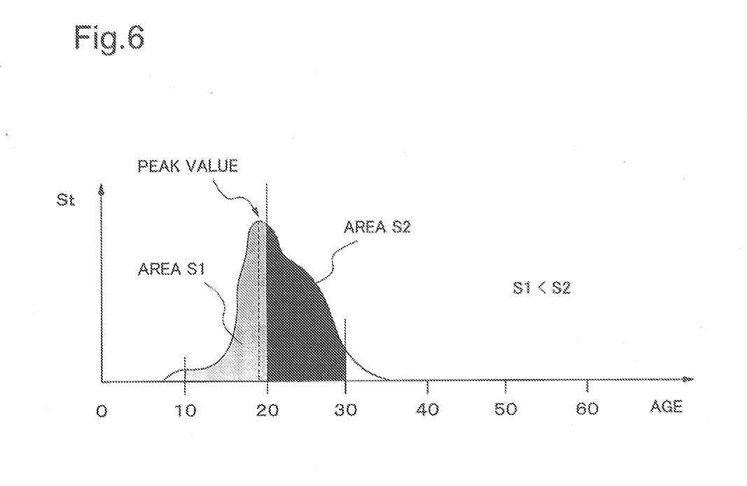

FIG. 7 A diagram showing a structure of an age presumption system according to the second exemplary embodiment in which the present invention is implemented suitably

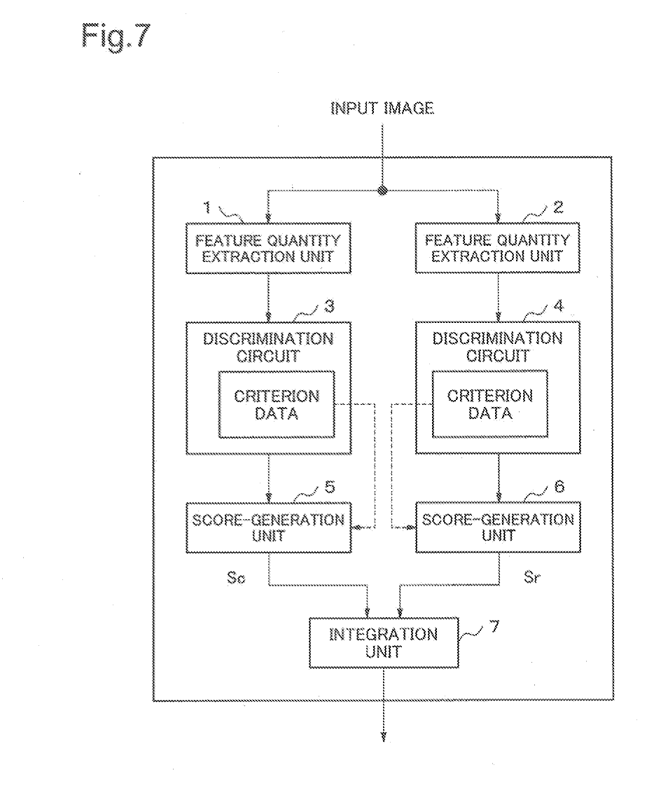

FIG. 8 A diagram showing an example of generating a score using criterion data

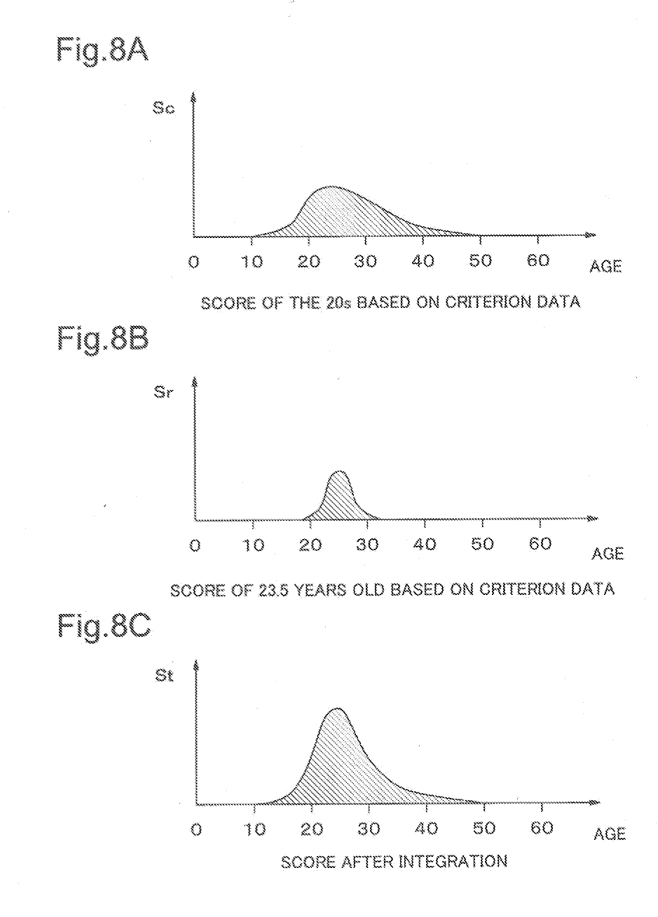

FIG. 9 A diagram showing a structure of an age presumption system according to the second exemplary embodiment in which the present invention is implemented suitably.

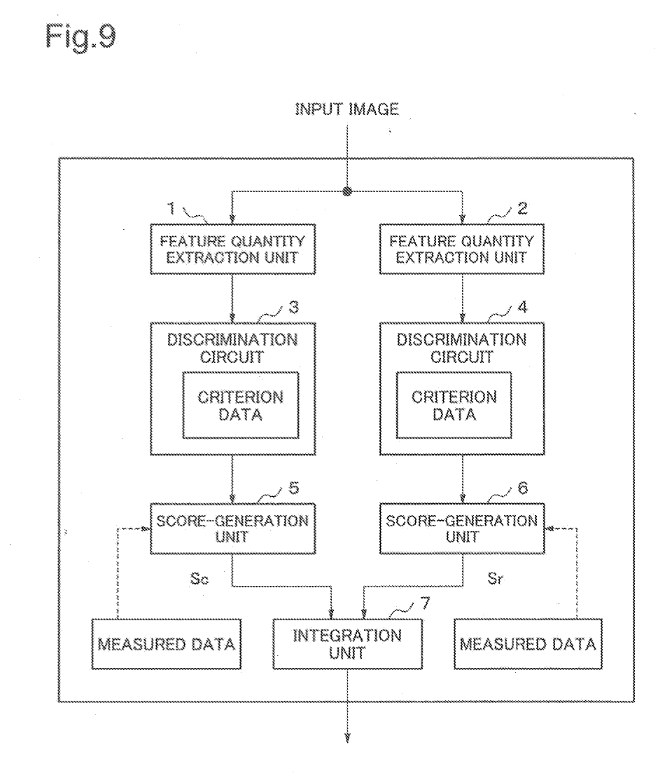

FIG. 10 A diagram showing a structure of an age presumption system according to the third exemplary embodiment in which the present invention is implemented suitably

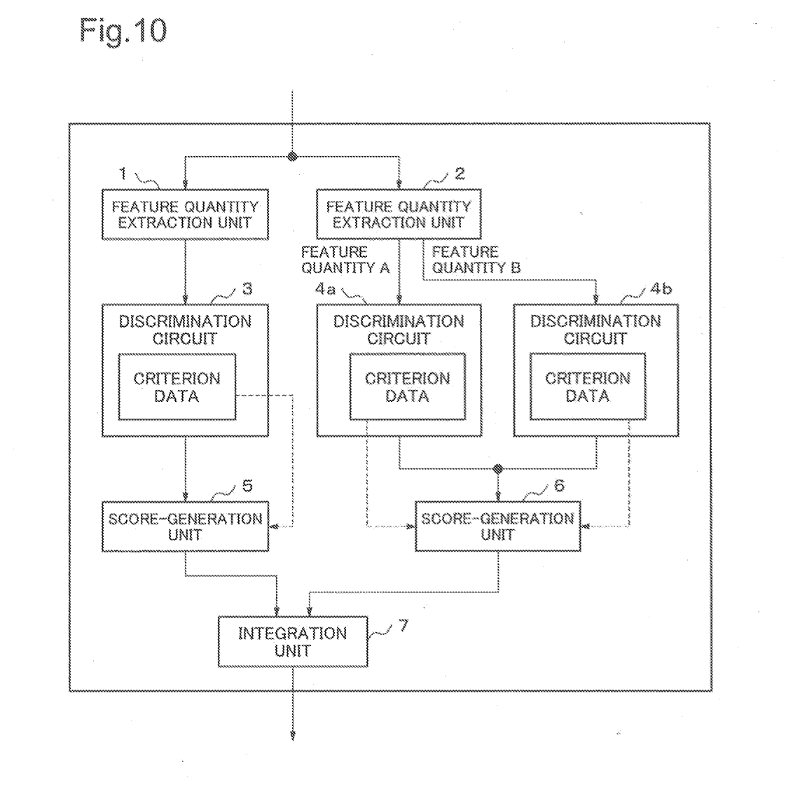

FIG. 11 A diagram showing an example of processing in which scores from presumed results of a plurality of discrimination circuits are combined

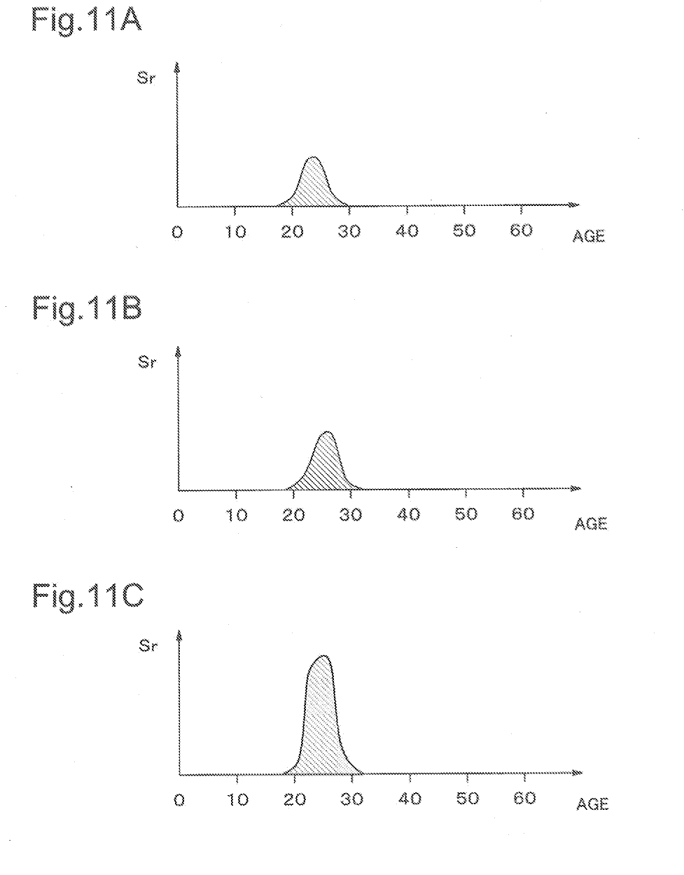

FIG. 12 A diagram showing a different structure of an age presumption system according to the third exemplary embodiment

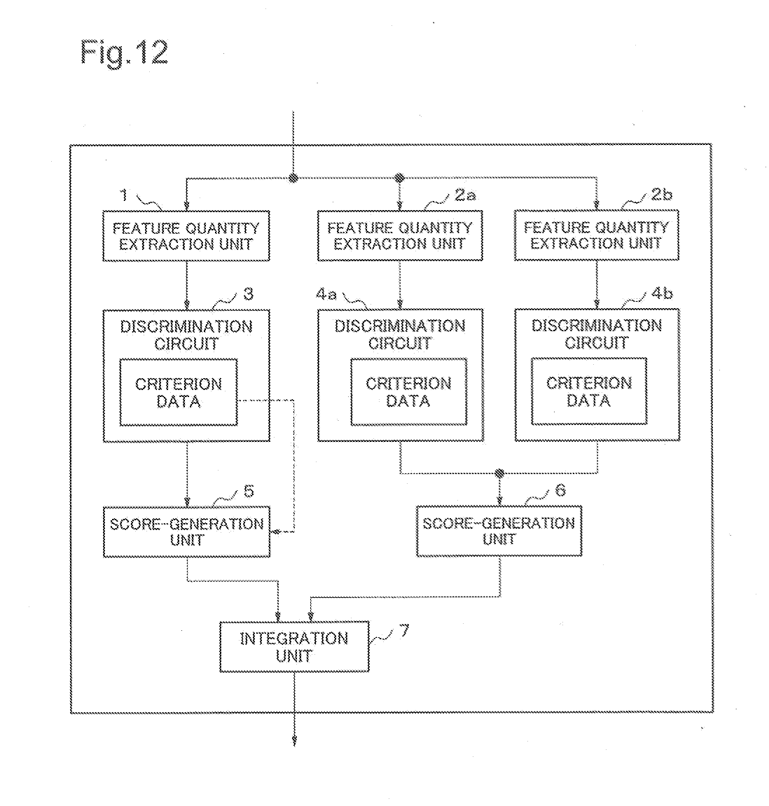

FIG. 13 A diagram showing a different structure of an age presumption system according to the third exemplary embodiment

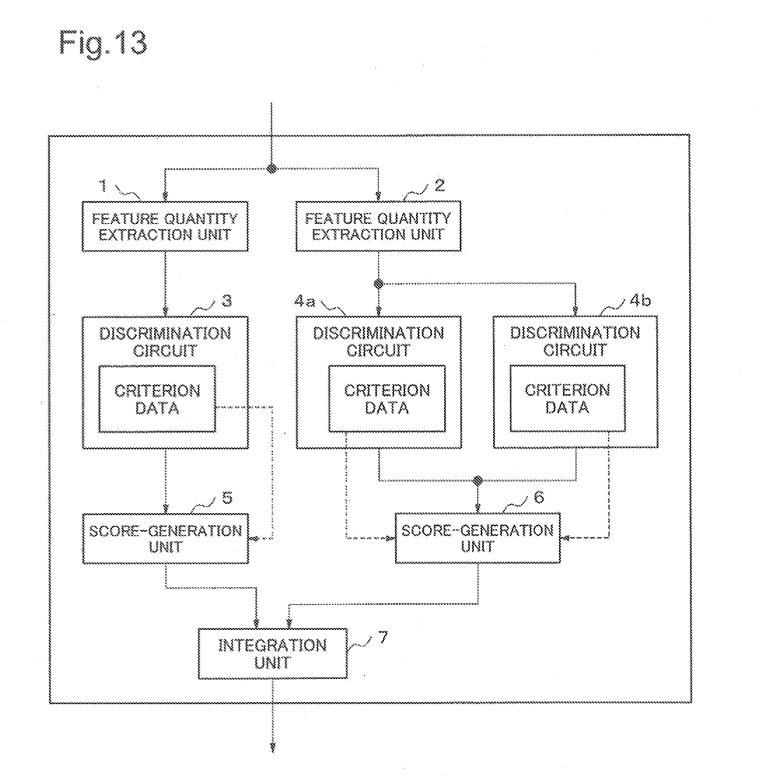

FIG. 14 A diagram showing a structure of an age presumption system according to the fourth exemplary embodiment in which the present invention is implemented suitably

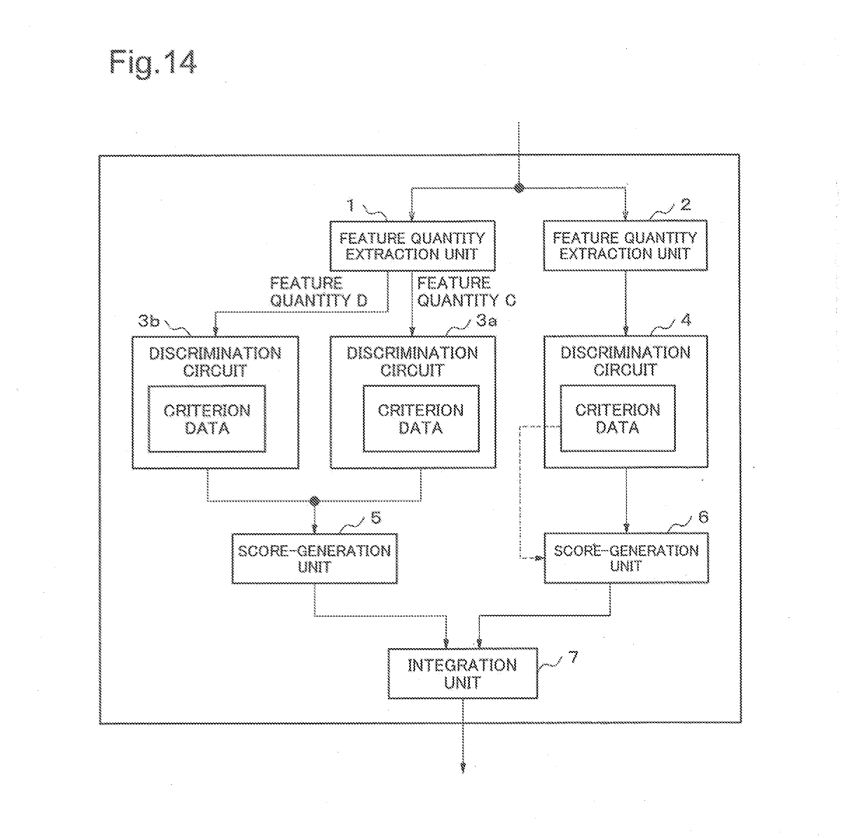

FIG. 15 A diagram showing a structure of an age presumption system according to the fifth exemplary embodiment in which the present invention is implemented suitably

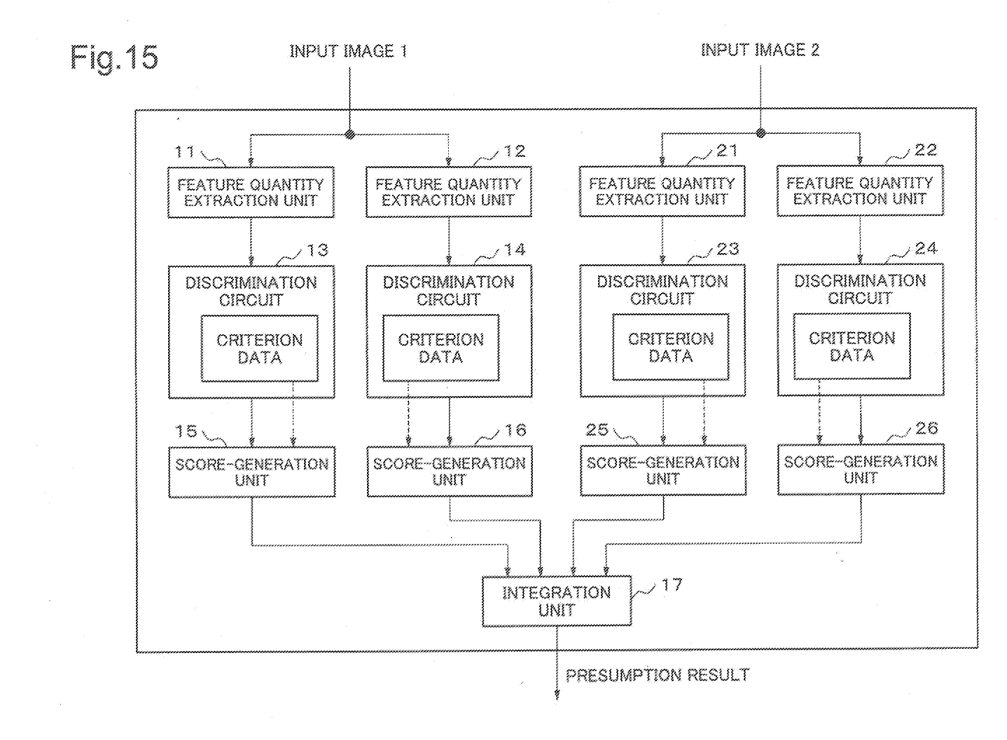

FIG. 16 A diagram showing a structure of a system to presume gender as well as age

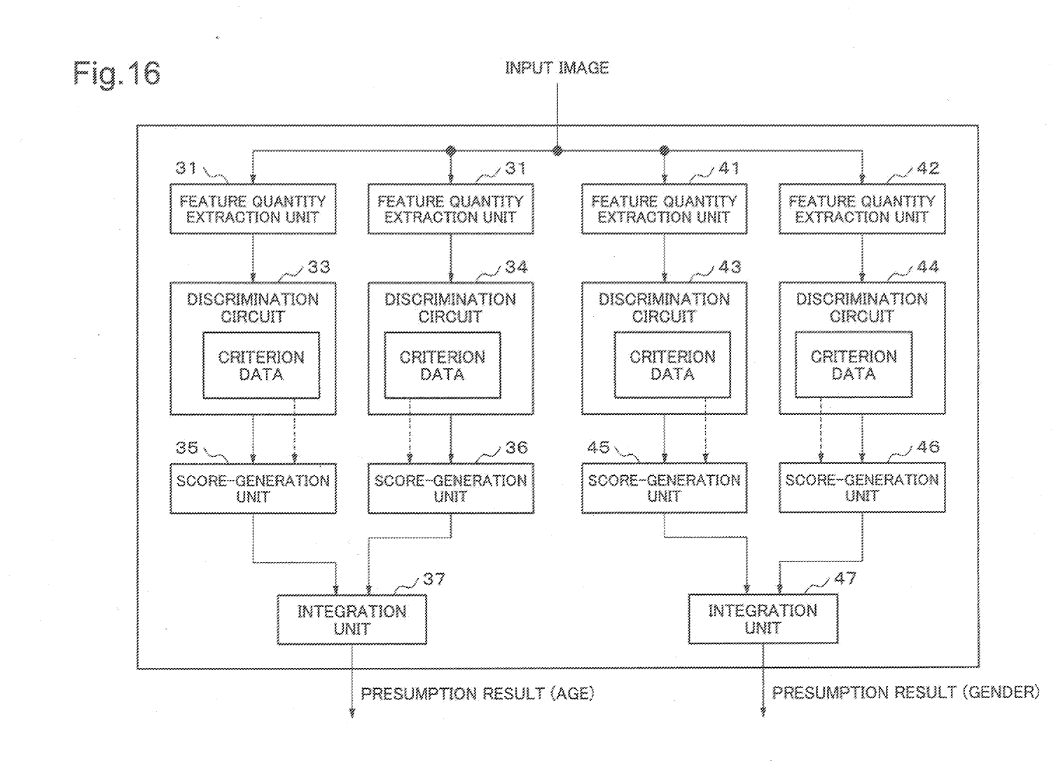

FIG. 17 A diagram showing a structure of an age presumption system in relation to the present invention

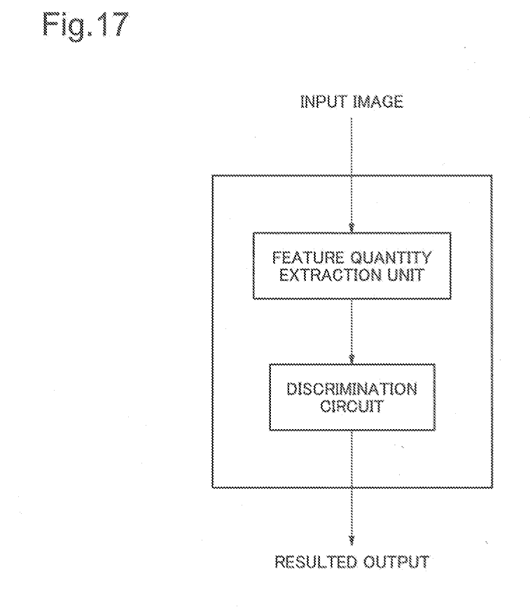

FIG. 18 A diagram showing an example of a structure of a tallying system of the present invention and a structure of a tallying apparatus of the present invention

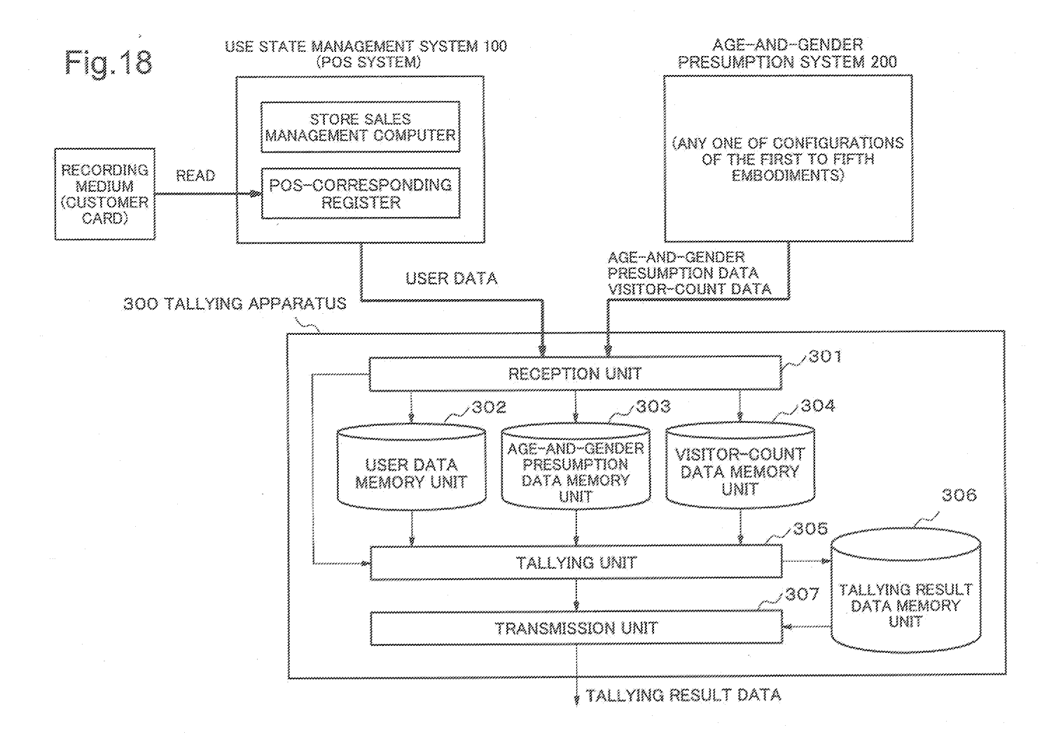

FIG. 19 A diagram showing an example of tallying result data generated by a tallying system of the present invention

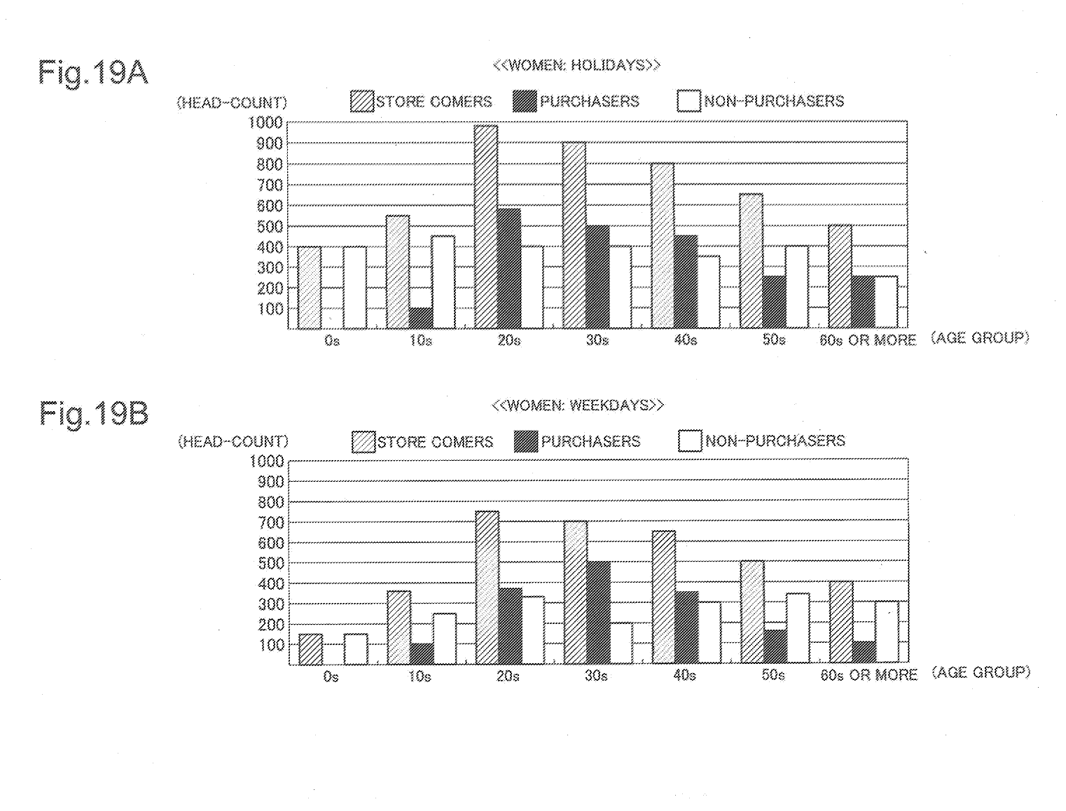

FIG. 20 A diagram showing an example of tallying result data generated by a tallying system of the present invention

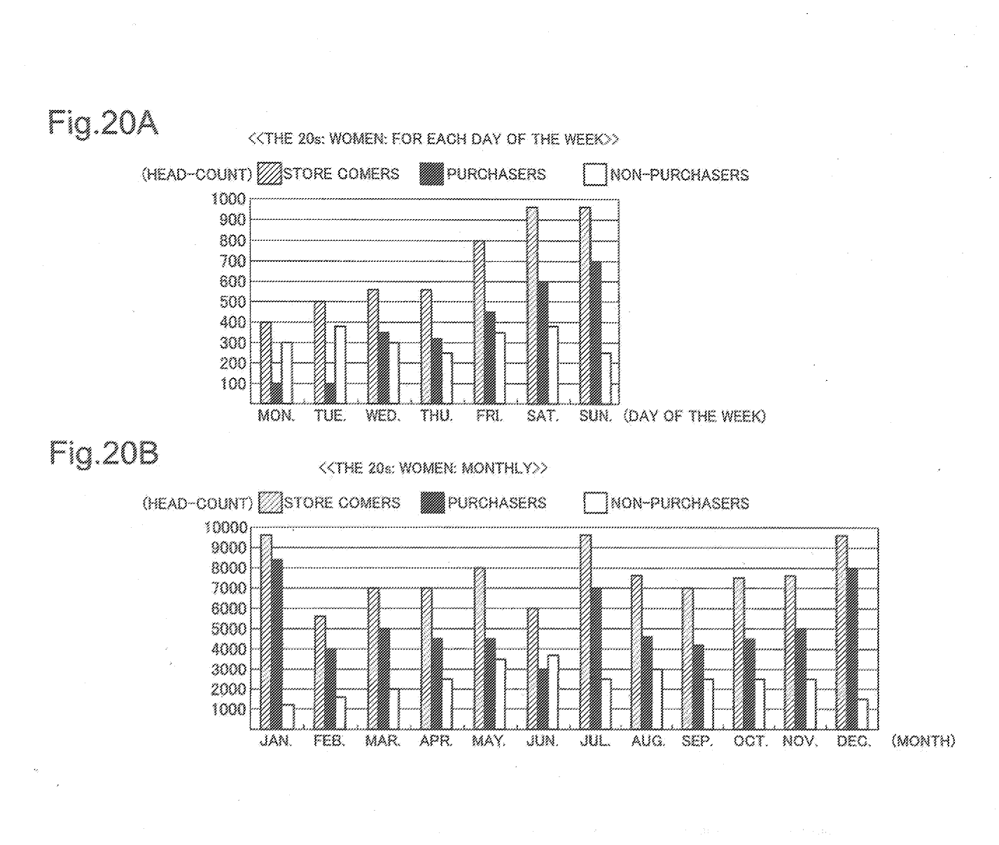

FIG. 21 A diagram showing an example of tallying result data generated by a tallying system of the present invention

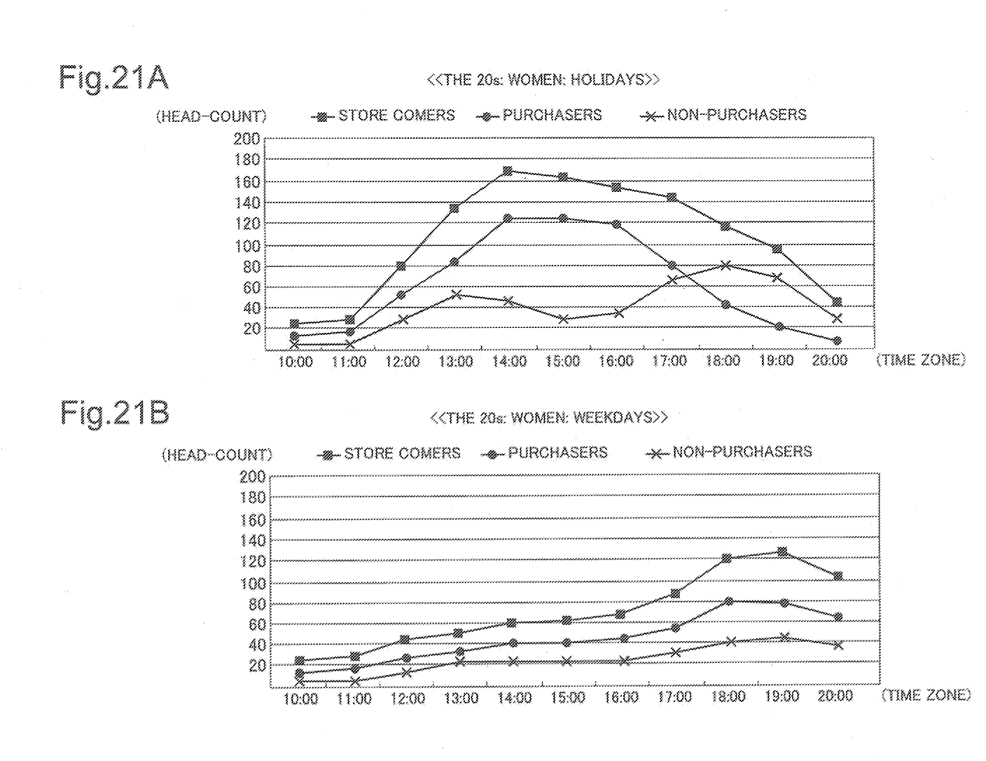

FIG. 22 A diagram showing an example of tallying result data generated by a tallying system of the present invention

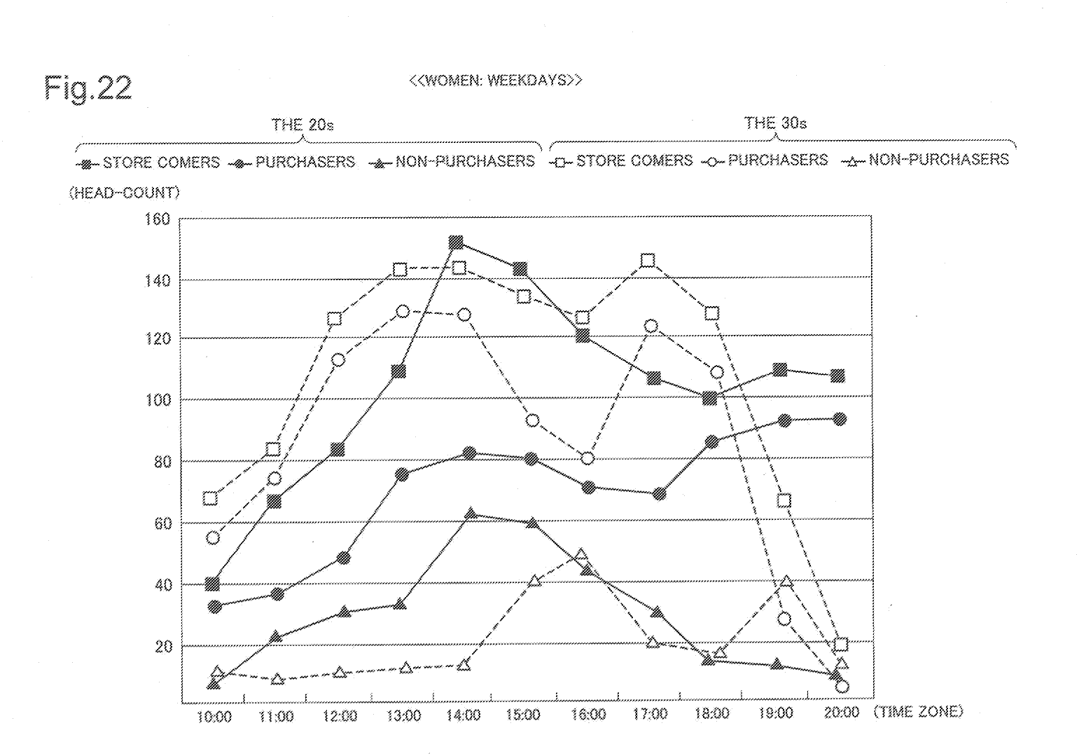

### DESCRIPTION OF THE NUMERALS

1, 2, 11, 12, 21, 22, 31, 32, 41, 42 Feature extraction unit;
3, 4, 13, 14, 23, 24, 33, 34, 43 and 44 Discrimination circuit;
5, 6, 15 16, 25 and 26 Score-generation unit;
7, 17, 37 and 47 Integration unit;
100 Use state management system (POS system);
200 Age-and-gender presumption system (characteristics presumption system);
300 Tallying apparatus;
301 Reception unit;
302 User data memory unit;
303 Age-and-gender presumption data memory unit;
304 Visitor-count data memory unit;
305 Tallying unit;
306 Tallying result data memory unit; and
307 Transmission unit

1. A tallying system comprising:
a characteristics presumption system which counts visitors to a predetermined place based on a predetermined input data to obtain visitor-count data, and presumes characteristics of said visitors based on said input data to obtain characteristics presumption data;
a use state management system which acquires user data indicating characteristics of users who have performed predetermined use among said visitors; and
a tallying apparatus which generates tallying result data including at least a result of tallying about characteristics of non-users besides said users among said visitors based on said visitor-count data and said characteristics presumption data received from said characteristics presumption system, and said user data received from said use state management system.

2. A tallying system according to claim 1, wherein
said characteristics presumption system comprising:
a first presumption device that presumes said visitor's characteristics as a discrete quantity based on said input data;
a second presumption device that presumes said visitor's characteristics as a continuous quantity based on said input data; and
a characteristics presumption data acquisition device that acquires at least one of a presumed result of said first presumption means device and a presumed result of said second presumption device as said characteristics presumption data.

3. A tallying system according to claim 2, wherein
said characteristics presumption data acquisition device performs integration of a presumed result of said first presumption device and a presumed result of said second presumption device to obtain a result of said integration as said characteristics presumption data.

4. A tallying system according to claim 2, wherein
said first presumption device comprising:
at least one first characteristics quantity extraction unit that extracts a first characteristics quantity of no smaller than one from said input data;
at least one first discrimination circuit that presumes said visitor's characteristics as a discrete value by comparing said first characteristics quantity with criterion data which has been already learned in advance.

5. A tallying system according to claim 2, wherein
said second presumption device comprising:
at least one second characteristics quantity extraction unit that extracts a second characteristics quantity of no smaller than one from said input data;
at least one second discrimination circuit that presumes said visitor's characteristics as a continuous value by comparing said second characteristics quantity with criterion data which has been already learned in advance.

6. A tallying system according to claim 2 comprising
an indexation unit that indexes relation between respective presumed results of said first presumption device and said second presumption device and an actual numerical value, wherein
said characteristics presumption data acquisition device integrates presumed results of said first and second presumption device that have been indexed by said indexation unit.

7. A tallying system according to claim 6, wherein
said indexation unit indexes respective presumed results of said first and second presumption device based on said criterion data.

8. A tallying system according to claim 1, wherein
said input data is at least one of image data and voice data.

9. A tallying system according to claim 1, wherein
said use state management system acquires user data from a recording medium possessed by said user in which said user data is recorded.

10. A tallying apparatus which is used in a tallying system according to claim 1.

11. A tallying method comprising:
a first data obtaining step for counting visitors to a predetermined place based on a predetermined input data to obtain visitor-count data, and presuming characteristics of said visitors based on said input data to obtain characteristics presumption data;
a second data obtaining step for obtaining user data indicating characteristics of users who have performed predetermined use among said visitors; and
a tallying step for generating tallying result data including at least a result of tallying about characteristics of non-users besides said users among said visitors based on said visitor-count data and said characteristics presumption data obtained in said first obtaining step and said user data obtained in said second data obtaining step.

12. A tallying method according to claim 11, wherein
said first data obtaining step comprising:
a first presumption step for presuming said visitor's characteristics as a discrete quantity based on said input data;
a second presumption step for presuming said visitor's characteristics as a continuous quantity based on said input data; and
a characteristics presumption data acquisition step for acquiring at least one of a presumed result in said first presumption step and a presumed result in said second presumption step as said characteristics presumption data.

13. A tallying method according to claim 12, wherein,
in said characteristics presumption data acquisition step,
integration of a presumed result of said first presumption step and a presumed result of said second presumption step is performed and a result of said integration is obtained as said characteristics presumption data.
